(19) United States
(12) Patent Application Publication
(10) Pub. No.: US 2015/0212561 A1
(43) Pub. Date: Jul. 30, 2015

(54) Apparatus and Method for Powering Electronic Devices by a Plurality of Power Sources

(71) Applicant: New Concepts Development Corp., Woodstock, IL (US)

(72) Inventor: Lawrence R. O'Connor, Austin, TX (US)

(21) Appl. No.: 14/501,561

(22) Filed: Sep. 30, 2014

Related U.S. Application Data
(60) Provisional application No. 61/860,157, filed on Jul. 30, 2013.

(51) Int. Cl. G06F 1/26; G06F 1/32

(52) U.S. Cl. CPC G06F 1/266; G06F 1/3287; G06F 1/3253

(57) ABSTRACT

The present invention relates to powering electronic peripheral devices. Specifically, the present invention relates to switching, combining, and/or partially using power sources to efficiently and fully power peripheral devices, especially devices with high demand in voltage and/or current. More specifically, the present invention relates to drawing power from a direct current port and an alternate power source.

The present invention claims priority to U.S. Provisional Patent Application No. 61/860,157, titled “Apparatus and Method for Powering Electronic Devices by a Plurality of Power Sources,” filed Jul. 30, 2013, which is incorporated herein by reference in its entirety.

### TECHNICAL FIELD

The present invention relates to powering electronic peripheral devices. Specifically, the present invention relates to switching, combining, and/or partially using two or more power sources to efficiently and fully power peripheral devices, especially devices with high demand in voltage and/or current. More specifically, the present invention relates to drawing power from at least one direct current port and at least one alternate power source.

### BACKGROUND

It is, of course, generally known to power electronic devices. Power, measured in watts, is voltage, measured in volts, multiplied by current, measured in amps. Electronic devices are usually powered with one power cable that may or may not have an alternating current to direct current (“AC/DC”) converter, typically because delivery of electrical power to homes and business is done via AC current. AC/DC converters generally have a transformer to adjust a power source's voltage to an acceptable level, a rectifier to convert the alternating current into a pulsing direct current, and a filter to convert the pulse into a direct current. These converters are generally device-specific because different devices require different operating voltage and current levels.

AC/DC converters are usually included with an electronic device when it is purchased. With so many different electronic devices available, there exists an overabundance of external power sources. A need, therefore, exists for an apparatus and method for powering electronic devices that either eliminates the need for external power sources or reduces the size of said external power sources.

Frequently, similar devices use similar voltage and/or current levels. When such devices fit into an industry standard, different types of external power sources are unnecessary. Additionally, universal AC/DC converters replace the need for multiple different external power sources. Moreover, a need exists for an apparatus and method for powering electronic devices that fits industry standards or is otherwise universal.

Often, devices are powered by computer ports, such as the Universal Serial Bus (“USB”). USB has had many generations including USB 1.0, 2.0, and 3.0. USB 2.0 is the most common and generally supplies 4.75 volts to 5.25 volts and up to 500 milliamps to a device. USB 3.0 generally supplies 4.45 volts to 5.25 volts and up to 900 milliamps. Computer port powering generally eliminates the need for external power sources for certain low power consuming devices. Likewise, a need exists for an apparatus and method for powering electronic devices through computer ports.

Commonly, electronic devices improve in efficiency and functionality over time. In many cases, improved electronic devices require more voltage and/or more current than previous generations of electronic devices. High-speed external disk drives, for example, require higher voltage and/or current levels than can be provided by a single computer port. Recently, Y-cables, having two USB connectors on a single end to draw power from two USB ports, have been used to obtain higher voltage and/or current. This requires the yet additional Y-cable to be produced, sold, and purchased by a consumer. Similarly, a need exists for an apparatus and method for powering electronic devices that can use standard cables.

Usually, increases in required voltage and/or current levels lead to new interfaces capable of handling such increases. The Thunderbolt™ interface was recently created to provide a maximum of 18 volts and 550 milliamps. While a Thunderbolt™ port can produce high voltage, it is still limited in current production. Some devices presently need, and further devices will need, more current that can be provided solely through a Thunderbolt™ port. Additionally, a need exists for an apparatus and method for powering electronic devices through a Thunderbolt™ port.

Generally, power is provided to a device by a single input, whether that input is an AC/DC converter, a USB, a Thunderbolt™, or a Y-cable. Traditionally, the single input has been improved to supply a device with the required voltage and/or current. Frequently, the single input is used for supplying power and other data transferring, such as the case with USB and Thunderbolt™. Commonly, however, inputs like USB or Thunderbolt™ are solely used for data transfer with an additional single input solely used for power. Furthermore, a need exists for an apparatus and method for powering electronic devices that takes advantage of multiple input ports.

### SUMMARY OF THE INVENTION

The present invention relates to powering electronic peripheral devices. Specifically, the present invention relates to switching, combining, and/or partially using power sources to efficiently and fully power peripheral devices, especially devices with high demand in voltage and/or current. More specifically, the present invention relates to drawing power from a direct current port and an alternate power source.

To this end, in an embodiment of the present invention, a power apparatus is provided. The power apparatus comprises: a first port capable of accepting a first cable, wherein the cable provides a first source of power to the power apparatus; a second port capable of accepting a second cable, wherein the second cable provides a second source of power to the power apparatus; and a controller for selectively powering a device using power from the first port, the second port, or a combination of the first port and the second port.

In an embodiment, the device is powered solely from the first port.

In an embodiment, the device is powered solely from the second port.

In an embodiment, the device is powered by a combination of power from the first port and the second port.

In an embodiment, the device is a peripheral device.

In an embodiment, the device is selected from the group consisting of a monitor, a storage device, an interface, a cellular device, and a media device.

In an embodiment, the power apparatus is integrally connected to the device.

In an embodiment, the power apparatus is removably connected to the device.

In an embodiment, the first port and the second port are the same type of port.

In an embodiment, the first port and the second port are different types of ports.

In an embodiment, the first port and the second port are each selected from the group consisting of a Thunderbolt port, a USB port and a DC power port.

In an embodiment, the first port is a Thunderbolt port and the second port is a USB port.

In an embodiment, the first port is a Thunderbolt port and the second port is a DC power port.

In an embodiment, the controller is a multiplexor for selectively combining power from the first port and the second port.

In alternate embodiment of the present invention, a power apparatus is provided comprising: a first port capable of accepting a first cable, wherein the cable provides a first source of power to the power apparatus; a second port capable of accepting a second cable, wherein the second cable provides a second source of power to the power apparatus, and further wherein the power apparatus switches between the first source of power and the second source of power.

In an embodiment, the power apparatus further comprises a controller for switching between the first source of power and the second source of power.

In an embodiment, the power apparatus further comprises a controller for combining the power from the first source of power and the second source of power.

In an embodiment, the power apparatus further comprises a controller comprising a multiplexor for selectively combining the power from the first source of power and the second source of power.

In an embodiment, the first port and the second port are each ports selected from the group consisting of a Thunderbolt port, a USB port and a DC power port.

In an embodiment, the power apparatus further comprises a device powered by the first source of power and the second source of power.

It is, therefore, an advantage of the present invention to provide an apparatus and method for powering electronic devices that eliminates the need for external power sources or significantly reduces the power needed from an external power source.

Moreover, it is an advantage of the present invention to provide an apparatus and method for powering electronic devices that fits industry standards or is otherwise universal.

Likewise it is an advantage of the present invention to provide an apparatus and method for powering electronic devices through computer ports.

Similarly, it is an advantage of the present invention to provide an apparatus and method for powering electronic devices that uses standard cables.

Additionally, it is an advantage of the present invention to provide an apparatus and method for powering electronic devices through a Thunderbolt™ port.

Furthermore, it is an advantage of the present invention to provide an apparatus and method for powering electronic devices that takes advantage of multiple input ports.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a block diagram of a dual power source apparatus in an embodiment of the present invention.

FIG. 2 illustrates an alternate block diagram of a dual power source apparatus in an alternate embodiment of the present invention.

### DETAILED DESCRIPTION OF THE PRESENTLY PREFERRED EMBODIMENTS

The present invention relates to powering electronic peripheral devices. Specifically, the present invention relates to switching, combining, and/or partially using power sources to efficiently and fully power peripheral devices, especially devices with high demand in voltage and/or current. More specifically, the present invention relates to drawing power from a direct current port and an alternate power source.

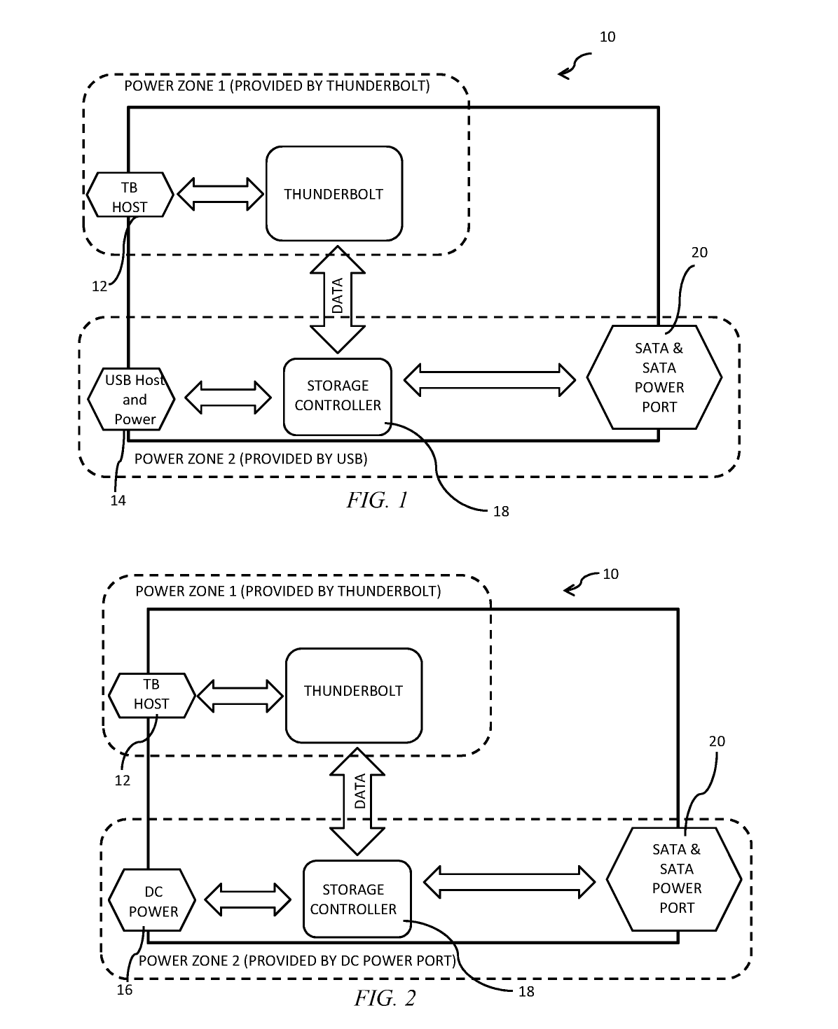

Now referring to the figures, wherein like numerals refer to like parts, FIG. 1 illustrate a dual power source apparatus 10 of the present invention. The apparatus 10 may be an integrated circuit on a motherboard, a stand-alone printed circuit board (“PCB”), an expansion card, or similar circuitry known to one skilled in the art. The apparatus 10 may include a plurality of ports such as a Thunderbolt™ port 12 and a USB port 14. As shown in FIG. 2, the USB port 14 may be replaced with a DC power port 16. The DC power port 16 may be any port that provides voltage and/or current flow. Of course, the Thunderbolt™ port 12 also may be replaced with a DC power port or any other power port known to one of ordinary skill in the art. For example, the present invention may have an AC/DC converter that may connect to the wall. Additionally, there may be more than two different power ports without departing from the scope of the present invention. The Thunderbolt™ port 12 may accept a Thunderbolt™ cable (not shown), the USB port 14 may accept a USB cable (not shown), and the DC power port 16 may accept a matching DC power cable (not shown).

The apparatus 10 may have a controller 18 to interface with the voltages and/or currents from each port. The voltages and/or currents from each port may be directed to the controller 18 wherein the voltages and/or currents may be selected, added, subtracted, divided, or otherwise combined. For example, the controller 18 may be a simple multiplexor that selects from a single voltage and/or current source, a sum of multiple voltage and/or current sources, a single voltage and/or current source that has been voltage divided, a sum of multiple voltage and/or current sources that have been voltage divided, a sum of a single positive voltage and/or current source and a single negative voltage and/or current source, or alternate combination known to one skilled in the art. Therefore, the controller 18 may switch between ports, draw power partially or completely from a single port, and draw power partially or completely from multiple different ports. The controller 18 may provide many different voltage and/or current levels through the use of multiple common ports, such as, but not limited to, USB, Thunderbolt™ and/or a common DC power port.

From the controller 18, a desired voltage and/or current may power a peripheral device. For example, as illustrated in FIGS. 1 and 2, the desired voltage and/or current may be directed to a Serial ATA 20, for example, or alternate bus interface. The Serial ATA 20 may join a connected device. The connected device may be a storage device, an interface, a monitor, a cellular device, a media device, or other device known to one skilled in the art. The connected device may house the power device 10 therein, such that the power device 10 may be a part of the connected device. The power device 10, however, may also be a peripheral device interconnected between a computer and a connected device.

The present invention thereby may power a peripheral device using different ports. The present invention may combine power from an AC/DC converter, from one port, from multiple ports, from some ports partially, or from any combination thereof.

The present invention illustratively disclosed herein may be appropriately practiced in the absence of any element which is not specifically disclosed herein. It should be further noted that various changes and modifications to the presently preferred embodiments described herein will be apparent to those skilled in the art. Such changes and modifications may be made without departing from the spirit and scope of the present invention and without diminishing its attendant advantages.

I claim:

1. A power apparatus comprising:
a first port capable of accepting a first cable, wherein the cable provides a first source of power to the power apparatus;
a second port capable of accepting a second cable, wherein the second cable provides a second source of power to the power apparatus; and
a controller for selectively powering a device using power from the first port, the second port, or a combination of the first port and the second port.

2. The power apparatus of claim 1 wherein the device is powered solely from the first port.

3. The power apparatus of claim 1 wherein the device is powered solely from the second port.

4. The power apparatus of claim 1 wherein the device is powered by a combination of power from the first port and the second port.

5. The power apparatus of claim 1 wherein the device is a peripheral device.

6. The power apparatus of claim 1 wherein the device is selected from the group consisting of a monitor, a storage device, an interface, a cellular device, and a media device.

7. The power apparatus of claim 1 wherein the power apparatus is integrally connected to the device.

8. The power apparatus of claim 1 wherein the power apparatus is removably connected to the device.

9. The power apparatus of claim 1 wherein the first port and the second port are the same type of port.

10. The power apparatus of claim 1 wherein the first port and the second port are different types of ports.

11. The power apparatus of claim 1 wherein the first port and the second port are each selected from the group consisting of a Thunderbolt port, a USB port and a DC power port.

12. The power apparatus of claim 1 wherein the first port is a Thunderbolt port and the second port is a USB port.

13. The power apparatus of claim 1 wherein the first port is a Thunderbolt port and the second port is a DC power port.

14. The power apparatus of claim 1 wherein the controller is a multiplexor for selectively combining power from the first port and the second port.

15. A power apparatus comprising:
a first port capable of accepting a first cable, wherein the cable provides a first source of power to the power apparatus;
a second port capable of accepting a second cable, wherein the second cable provides a second source of power to the power apparatus, and further wherein the power apparatus switches between the first source of power and the second source of power.

16. The power apparatus of claim 15 further comprising:
a controller for switching between the first source of power and the second source of power.

17. The power apparatus of claim 15 further comprising:
a controller for combining the power from the first source of power and the second source of power.

18. The power apparatus of claim 15 further comprising:
a controller comprising a multiplexor for selectively combining the power from the first source of power and the second source of power.

19. The power apparatus of claim 15 wherein the first port and the second port are each ports selected from the group consisting of a Thunderbolt port, a USB port and a DC power port.

20. The power apparatus of claim 15 further comprising:
a device powered by the first source of power and the second source of power.
